(19) United States
(12) Patent Application Publication
(10) Pub. No.: US 2006/0047384 A1
(43) Pub. Date: Mar. 2, 2006

(54) Data recorder module

(76) Inventors: Timothy A. Robinson, Avon, IN (US); James H. Stewart, Gulfport, MS (US); Russell C. Scharbrough II, Indianapolis, IN (US); Michael A. Windisch, Indianapolis, IN (US)

Correspondence Address: CHRISTOPHER DEVRIES;General Motors Corporation, Mail Code 482-C23-B21, P.O. Box 300, Detroit, MI, 48265-3000, US

(21) Appl. No.: 11/144,160

(22) Filed: Jun. 3, 2005

Related U.S. Application Data
(60) Provisional application No. 60/604,773, filed on Aug. 26, 2004.

(51) Int. Cl. G06F 19/00

(52) U.S. Cl. 701/35; 701/29; 340/438

(57) ABSTRACT

A maintenance system for a vehicle including a component or system having a measurable characteristic is provided. The maintenance system monitors, stores and/or transmits data representative of the operation of the component or system, whereby the transmitted data may be analyzed and vehicle performance improved through the analysis thereof.

### CROSS REFERENCE TO RELATED APPLICATONS

This Application claims the benefit of U.S. Provisional Application 60/604,773, filed Aug. 26, 2004, which is hereby incorporated by reference in its entirety.

### BACKGROUND OF THE INVENTION

Onboard vehicle maintenance systems, diagnostic systems, engineering development devices, and testing systems that monitor vehicular components and systems typically rely on manual input from an operator and/or technician, and require the physical presence of the vehicle during analysis. An automated data collection and transmission system would provide the ability to observe the behavior of vehicular components and systems in the field, as the components and systems are being operated, which would provide significant advantages to vehicle manufacturers.

### SUMMARY OF THE INVENTION

A maintenance system for a vehicle including a component or system having a measurable characteristic is provided. The maintenance system includes at least one sensor configured and positioned with respect to the component or system to measure, to obtain a value for the measurable characteristic.

The sensor transmits a signal indicating the value of the measurable characteristic to a microprocessor. The microprocessor is configured to analyze the value of the measurable characteristic and thereby identify correctable aberrations in the vehicle's operation. The microprocessor is further configured to transmit the value of the measurable characteristic which may be indicative of a potential aberration to a user interface.

Preferably, the maintenance system includes a data recorder module for transmitting values of the measurable characteristic to an offboard network or data collection device, and for receiving instructions to correct aberrations in the vehicle's operation. The maintenance system is thus able to regularly communicate performance data of the component or system to an offboard network for use by a technician or others.

The ability to transmit data from a vehicle to a remote location is particularly advantageous, for example, when a vehicle is inaccessible. Vehicles are often tested in distant, environmentally extreme locations and the ability to collect vehicle data from vehicles in such locations without physically visiting the vehicles (i.e. remotely from the vehicles) would simplify the process of vehicle testing. Further, a system that allows an engineer to collect data from a vehicle that is being operated by a consumer would allow the engineer access to vehicle system data without taking control of the vehicle away from the consumer.

An automated data collection and transmission system is also preferably provided. Such a system removes the obligation of manually controlling data collection while retaining the advantages inherent in manual data collection. Such a system provides valuable advantages over strictly manual data collection systems. An automated data collection system eliminates user error, thereby improving the quality of the data. Further, an automated data collection system potentially provides for detection of vehicle malperformance prior to its detection by the operator. Automated vehicle system data collection also improves vehicle performance in a vast multitude of driving conditions by continuously monitoring the vehicle and adjusting its systems to function at peak performance depending upon the vehicle's physical location and current environment.

The maintenance system of the present invention is preferably composed of hardware adapted to initialize quickly after power up thereby allowing data collection much sooner after vehicle ignition than previously possible. Additionally, the maintenance system is preferably configured to automatically power-down after the vehicle's ignition is turned off such that the vehicle battery is not drained.

The above features, and advantages, and other features, and advantages, of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a maintenance system in accordance with an aspect of the invention;

FIG. 2 is a more detailed schematic illustration of the maintenance system of FIG. 1; and

FIG. 3 is a schematic illustration of a data recorder module in accordance with an aspect of the invention.

### DESCRIPTION OF THE PREFERRED EMBODIMENTS

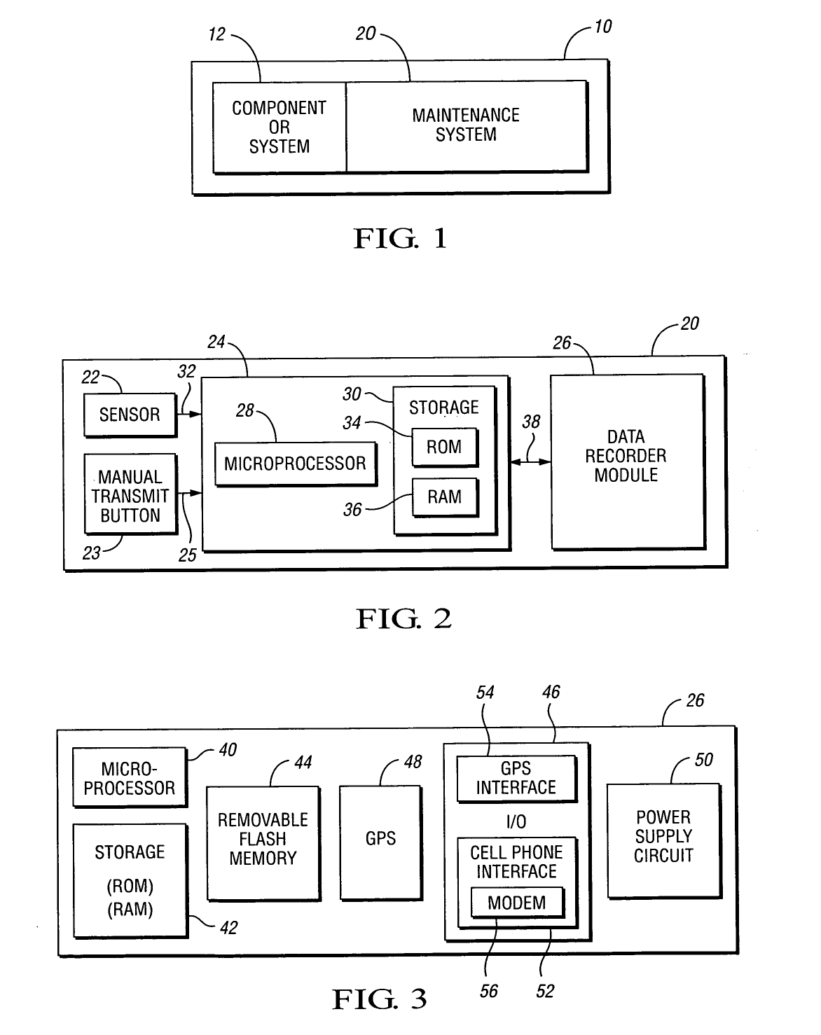

FIG. 1 is a schematic depiction of a maintenance system or device 20 installed in a vehicle 10. The vehicle 10 includes a plurality of components and systems, including a steering system; a braking system; a fuel storage system; an engine; a heating, ventilating and air conditioning system; a battery; a transmission; a motor; an alternator; a fuel pump; a water pump; a regulator; etc. One or more of these components or systems being monitored will be identified as component or system 12 (which may include any of the above listed systems, for example). For purposes of this disclosure, the monitored component or system 12 will be described hereinafter as the transmission, however, it should be appreciated that the monitored component or system 12 may include any or all of the above listed systems. In the context of the example wherein the transmission is being monitored, examples of measurable characteristics include engine speed, turbine speed, transmission input speed, transmission output speed, apply chamber pressure, etc.

Referring to FIG. 2, the maintenance system 20 includes a plurality of sensors 22, one or more electric control unit or ECU 24, and a data recorder module 26. The electronic control unit 24 further includes a microprocessor 28, and a data storage medium 30. According to a preferred embodiment, the maintenance system 20 also includes a manual transmit button 23 that is preferably disposed within the vehicle's passenger compartment and is electronically connected to the ECU 24. The manual transmit button 23 generates a transmit signal 25 telling the ECU 24 to transmit the recorded data, and thereby allows an occupant of the vehicle to manually transmit the data if, for example, the vehicle is operating abnormally. As will be described in detail hereinafter, the ECU 24 transmits data to and receives data from the data recorder module 26 in the form of recorder signals 38.

The maintenance system 20 is preferably mounted with respect to the component or system 12 and is configured to monitor, record and/or transmit performance data pertaining to the component or system 12. The maintenance system 20 may also be configured to monitor internal communication such as bus traffic between a plurality of control modules (not shown) mounted to and adapted to control the component or system 12. “Performance data” preferably includes, for example, values of measurable characteristics; a unique system or component identifier such as a part number; a unique vehicle identifier such as a vehicle identification number; and an indicator of the presence or absence of a predetermined fault condition. The electronic control unit 24 is configured to automatically transmit the stored performance data from the storage medium 30 to the data recorder module 26 at predetermined intervals or triggering events. Triggering events may include, for example, the presence of a fault condition; the beginning of vehicle operation, such as whenever a vehicle user turns an ignition key to start the vehicle; the completion of vehicle operation, such as whenever a vehicle user turns an ignition key to stop the vehicle; direct input from an operator, such as a dedicated switch; direct input from a technician, such as through a telematic connection; etc.

The sensors 22 may include, for example, voltmeters, position sensors, velocity sensors, acceleration sensors, pressure sensors, force and torque sensors, flow meters, temperature sensors, etc. The sensors 22 are positioned and configured with respect to the monitored component or system 12 to measure, and thereby obtain a value for, at least one of the measurable characteristics of the component or system 12. Each of the sensors 22 is configured to transmit a sensor signal 32 indicating the value of one of the measurable characteristics to the electronic control unit 24.

The data storage medium 30 preferably includes ROM 34 and RAM 36. The ROM 34 preferably includes the basic operating system of the electronic control module 24 and any other data and parameters which generally require permanent storage. The function of the RAM 36 includes the manipulation and storage of vehicle process variables and other vehicle data.

The microprocessor 28 is configured to generate data representative of component or system 12 operation in response to sensor signals 32, and transmit the data to the data recorder module 26. In a preferred embodiment, the microprocessor 28 automatically transmits such data to the data recorder module 26 in response to the presence of a predetermined fault condition such as, for example, when the data falls outside a predefined range. In this manner, data which may be indicative of an aberration in the vehicle's operation is automatically made available for further analysis without any operator input. The microprocessor 28 may also optionally be configured to transmit such data in response to direct operator input from the manual transmit button 23, during periodic intervals, in response to a signal from the data recorder module, or any other known manner.

The data recorder module 26 is configured to store and/or transmit data received from the ECU 24. The data recorder module 26 preferably includes a microprocessor 40, a data storage device 42 (preferably including RAM and ROM), removable flash memory 44, an input/output interface 46, a global positioning system or GPS circuit 48, and a power supply circuit 50.

The input/output interface 46 is preferably adapted to accommodate a cell phone interface 52 and a GPS interface 54 to connect to PC mapping software. The cell phone interface 52 preferably includes a modem connection 56 and allows an off site technician to prompt the ECU 24 to record and/or transmit data representative of component or system 12 operation. In an alternate embodiment, the ECU 24 may be programmed to automatically send such data via the cell phone interface 52. The GPS interface 54 is adapted to work in conjunction with the GPS circuit 48 to provide information such as the location of the vehicle, vehicle altitude, vehicle speed, etc.

In a preferred embodiment, a vehicle operator may utilize the removable flash memory 44 to retrieve stored data, and thereafter transfer the memory device to a technician for later analysis. This embodiment facilitates the analysis of a vehicle's operation without unnecessary inconvenience to either the vehicle operator or the technician, however, any number of alternate data storage devices may additionally be envisioned.

In an alternate embodiment, the data recorder module 26 is configured to transmit the performance data received from the electronic control unit 24 to an offboard network. The data recorder module 26 is preferably wireless to enable automatic transmission of the stored performance data without geographic constraints. Those skilled in the art will recognize a variety of wireless communications apparatuses that may be employed within the scope of the claimed invention. For example, a vehicle telematics system configured to transmit data via satellite or cellular network may be used. Preferably, the predetermined intervals or triggering events are not limited to the presence of a fault condition to ensure a regular flow of performance data to the offboard network.

The data recorder module 26 is also configured to receive maintenance system programming data from the offboard network. Programming data includes, for example, software and updated or additional statistical data. The microprocessor 28 is preferably reprogrammable with programming data received via the data recorder module 26 such that operation of the component or system 12 is modifiable to improve vehicle performance.

The power supply circuit 50 is configured to detect shutdown of the vehicle 10. When vehicle shutdown is detected, the power supply circuit 50 powers the data recorder module 26 long enough to allow the microprocessor 40 to save relevant data on one or more of the data storage devices described hereinabove. After the relevant data has been saved, the data recorder module 26 is powered-down by the power supply circuit 50. In this manner, the vehicle's battery (not shown) is not unnecessarily drained because the data recorder module 26 is powered by the power supply circuit 50 when the vehicle 10 is not running. Additionally, energy is conserved by automatically powering-down the data recorder module 26 after the relevant data has been saved.

The maintenance system described herein may be used in conjunction with any component or system that is subject to degradation. For example, components or systems in aircraft, computers, power generation equipment, manufacturing systems, machines, robots, etc, can be monitored by a maintenance system substantially as described herein. Performance data from these components or systems may be collected and exploited substantially as described herein.

As set forth in the claims, various features shown and described in accordance with the different embodiments of the invention illustrated may be combined.

While the best modes for carrying out the invention have been described in detail, those familiar with the art to which this invention relates will recognize various alternative designs and embodiments for practicing the scope of the invention within the scope of the appended claims.

1. A maintenance device for a vehicle system, the maintenance device comprising:
a sensor configured to measure a measurable characteristic of the vehicle system, and to transmit a sensor signal indicative of the measured value of the measurable characteristic;
an electronic control unit configured to receive the sensor signal and to generate data representative of the measured value of the measurable characteristic, and to selectively transmit said data in response to one or more predefined prompts;
a recorder module adapted to receive the selectively transmitted data and to transfer the data in a convenient manner such that vehicle operation can be evaluated remotely from the vehicle; and
a power supply circuit adapted to temporarily power the recorder module after the vehicle has been turned off such that any data that has not been transferred may be preserved, and thereafter the power supply circuit is configured to power-down the recorder module such that energy is conserved while the vehicle is off.

2. The maintenance device of claim 1, wherein said recorder module further includes a storage device adapted to record said data.

3. The maintenance device of claim 1, wherein said recorder module further includes a removable flash memory device adapted to record said data such that the flash memory device with the recorded data may be removed from the vehicle and conveniently transferred.

4. The maintenance device of claim 1, wherein said recorder module further includes a modem adapted to transmit said data.

5. The maintenance device of claim 1 further comprising a global positioning system.

6. The maintenance device of claim 1 further comprising a manual transmit button adapted to allow an occupant of the vehicle to manually prompt the electronic control unit to transmit said data.

7. The maintenance device of claim 1, wherein said electronic control unit further comprises a microprocessor adapted to automatically transmit said data in response to the presence of a predetermined fault condition.

8. The maintenance device of claim 1, wherein said electronic control unit further comprises a microprocessor adapted to transmit said data at periodic intervals.

9. The maintenance device of claim 1, wherein said electronic control unit further comprises a microprocessor adapted to automatically transmit said data in response to a signal from the recorder module.

10. The maintenance device of claim 1, wherein said electronic control unit further comprises a reprogrammable microprocessor adapted to automatically reprogram in response to programming data received from the recorder module to improve vehicle performance.

11. A maintenance device for a vehicle system, the maintenance device comprising:
a sensor configured to measure a measurable characteristic of the vehicle system, and to transmit a sensor signal indicative of the measured value of the measurable characteristic;
an electronic control unit configured to receive the sensor signal and to generate data representative of the measured value of the measurable characteristic, and to selectively transmit said data in response to one or more predefined prompts;
a recorder module adapted to receive the selectively transmitted data and to transfer the data in a convenient manner such that vehicle operation can be evaluated remotely from the vehicle;
a global positioning system adapted to provide the analyst the location of the vehicle; and
a power supply circuit adapted to temporarily power the recorder module after the vehicle has been turned off such that any data that has not been transferred may be preserved, and thereafter the power supply circuit is configured to power-down the recorder module such that energy is conserved while the vehicle is off.

12. The maintenance device of claim 11, wherein said recorder module further includes a removable flash memory device adapted to record said data such that the flash memory device with the recorded data may be removed from the vehicle and conveniently transferred.

13. The maintenance device of claim 11, wherein said recorder module further includes a modem adapted to transmit said data.

14. The maintenance device of claim 11, wherein said electronic control unit further comprises a reprogrammable microprocessor adapted to automatically reprogram in response to programming data received from the recorder module to improve vehicle performance.

15. A method for monitoring a vehicle system, the method comprising:
measuring a measurable characteristic of the vehicle system;
generating data representative of the measured value of the measurable characteristic;
selectively transmitting said data to a recorder module in response to one or more predefined prompts;
transferring said selectively transmitted data in a convenient manner such that vehicle operation can be evaluated remotely from the vehicle;
supplying power to said recorder module after the vehicle has been turned off such that any data that has not been transferred may be preserved; and
powering-down said recorder module after said data has been preserved such that energy is conserved while the vehicle is off.

16. The method of claim 15 further comprising transmitting the location of the vehicle to the analyst from a global positioning system.

17. The maintenance system of claim 15, wherein said transferring said selectively transmitted data includes saving said data onto a removable flash memory device and transferring the removable flash memory device with the saved data.

18. The maintenance system of claim 15, wherein said transferring said selectively transmitted data includes transmitting said data to the analyst using a modem.
